(19) United States
(12) Patent Application Publication
(10) Pub. No.: US 2024/0336727 A1
(43) Pub. Date: Oct. 10, 2024

(54) Polymer Composition With Flame and Electrical Tracking Resistance

(71) Applicant: Celanese International Corporation, Irving, TX (US)

(72) Inventors: Qamer Zia, Raunheim (DE); Kirsten Markgraf, Weinheim (DE); Dirk Zierer, Hattersheim (DE); Patrick Nickolay, Villmar (DE)

(21) Appl. No.: 18/627,529

(22) Filed: Apr. 5, 2024

Related U.S. Application Data
(60) Provisional application No. 63/494,499, filed on Apr. 6, 2023.

(51) Int. Cl. C08G 63/183; C08J 5/04; C08K 3/04; C08K 3/32; C08K 5/3492; C08K 7/14; C08L 77/02; C08L 77/04

(52) U.S. Cl. CPC C08G 63/183; C08J 5/043; C08K 3/04; C08K 3/32; C08K 5/34924; C08K 7/14; C08L 77/02; C08L 77/04; C08J 2367/04; C08J 2377/02; C08J 2377/04; C08K 2201/003; C08K 2201/004; C08K 2201/019; C08L 2201/02; C08L 2203/20

(57) ABSTRACT

Thermoplastic polymer compositions are disclosed that demonstrate a flame resistance rating of V-0 at a thickness of 0.8 mm and a Comparative Tracking Index of 600 V. The polymer compositions can contain a glass-reinforced polyester polymer, namely a polybutylene terephthalate polymer. A flame retardant composition is combined with the polymer composition in addition to one or more insulating adjuvants.

### RELATED APPLICATIONS

The present application is based upon and claims priority to U.S. Provisional Patent Application Ser. No. 63/494,499, having a filing date of Apr. 6, 2023, which is incorporated herein by reference.

### BACKGROUND

Engineering thermoplastics are often used in numerous and diverse applications in order to produce molded parts and products. For instance, polyester and polyamide polymers are used to produce all different types of molded products, such as injection molded products, blow molded products, and the like. Polyester polymers, for instance, can be formulated in order to be chemically resistant, to have excellent strength properties and, when formulating compositions containing polyester elastomers, to be flexible. Of particular advantage, polyester polymers can be melt processed due to their thermoplastic nature. In addition, polyester polymers can be recycled and reprocessed.

One problem faced by those skilled in the art in producing molded parts and products from thermoplastic polymers is the ability to make the articles flame resistant. Although almost a limitless variety of different flame retardants are marketed and sold commercially, selecting an appropriate flame retardant for a particular thermoplastic polymer composition is difficult and unpredictable. Further, many available flame retardants contain halogen compounds, such as bromine compounds, which can produce harsh chemical gases during production.

Another problem faced by those skilled in the art in producing molded parts and products from polyester polymers is the ability to increase the electrical insulation properties of articles made from the polymers, especially when the articles are also to possess flame resistance. Electrical insulation properties are needed, for instance, when the polymer composition is molded to form electrical components.

One area where flame resistance and electrical insulation properties are needed, for instance, is when using thermoplastic polymers to design and produce connectors, particularly high-voltage connectors. High-voltage connectors are designed to make a detachable electrical connection with high-voltage components, such as components that make up the electrical drive system of a motor vehicle. High-voltage connectors, for instance, are particularly high in demand due to the evolution of hybrid vehicles, electrical vehicles, and fuel cell vehicles.

Modern electrical drive systems of electric vehicles, for instance, include numerous high-voltage components or assemblies where the high-voltage devices operate at voltages of greater than 300 V. These include power control elements, such as inverters, current converters and/or power converters, and/or electronic controller units.

The high-voltage connectors are designed to operate in high-voltage environments while providing protection against electrical shock. These connectors may also need to operate at high temperatures and in high humidity environments.

In many applications, however, when measures are taken in order to increase flame resistance, the electrical insulation properties of the polymer can be degraded or vice versus. In fact, there is great demand for increasing the electrical resistance of thermoplastic polymers without affecting other properties of the polymer composition. The present disclosure is directed to a thermoplastic polymer composition having an improved combination of flame retardant properties and electrical tracking resistance.

### SUMMARY

In general, the present disclosure is directed to a polymer composition containing a thermoplastic polymer, such as a polyester polymer, in conjunction with a flame retardant composition and at least one insulating adjuvant. The components of the flame retardant composition are carefully selected in order to produce a polymer composition having improved fire resistant properties. For example, the polymer composition can display a V-0 rating at a thickness of only 0.8 mm when tested according to Underwriters Laboratories Test 94.

In one embodiment, for instance, the present disclosure is directed to a flame resistant polymer composition that contains a thermoplastic polymer, such as a polyester polymer. The polyester polymer can be present in the polymer composition generally in an amount greater than about 35% by weight, such as in an amount greater than about 40% by weight, such as in an amount greater than about 45% by weight. The polyester thermoplastic polymer may be a polybutylene terephthalate polymer. In one embodiment, the polyester polymer (e.g. polybutylene terephthalate polymer) can contain a limited amount of carboxyl end groups. The polyester polymer may contain carboxyl end groups in an amount less than about 20 mmol/kg.

In accordance with the present disclosure, the thermoplastic polymer is combined with a non-halogen flame retardant composition comprising a metal phosphinate. The metal phosphinate may be a dialkyl phosphinate, such as aluminum diethyl phosphinate. In one aspect, the flame retardant composition can optionally contain a nitrogen-containing synergist. The nitrogen-containing synergist can comprise a melamine, such as melamine cyanurate. In one aspect, the metal phosphinate is present in the polymer composition in an amount from about 10% to about 30% by weight, such as from about 10% to about 25% by weight, such as in an amount from about 10% to about 19% by weight. The nitrogen-containing synergist, on the other hand, can be present in the polymer composition generally in an amount from about 0.01% to about 12% by weight, such as from about 2% to about 9% by weight, such as from about 3% to about 8.5% by weight.

In accordance with the present disclosure, the polymer composition also contains one or more insulating adjuvants. The insulating adjuvant, for instance, can be a polymer, a mineral filler, or a mixture of both. Polymers that can be selected as insulating adjuvants can possess one or more various physical properties. For instance, in one aspect, the polymeric insulating adjuvant can have a critical surface tension of less than about 40 dynes/cm, such as less than about 39 dynes/cm, such as less than about 38 dynes/cm, and greater than 5 dynes/cm. Alternatively or in addition, a polymeric insulating adjuvant can display a contact angle of greater than about 70°, such as greater than about 72°, such as greater than about 75°, such as greater than about 77°, such as greater than about 80°, and less than about 120°. Critical surface tension can be measured according to ASTM Test D-2578 (2017). Contact angle can be measured according to ASTM Test D-5946 (2017).

In another aspect, polymers well suited for use as an insulating adjuvant, for instance, can display a surface resistivity of greater than 1011 ohm and a water absorption of less than about 2.5%.

Examples of polymeric insulating adjuvants include longer chain aliphatic polyamides, silicone polymers, waxes, and the like. In one aspect, the insulating adjuvant can be polyamide 11, polyamide 12, or mixtures thereof.

Alternatively, the insulating adjuvant can be a silicone polymer. The silicone polymer can have a low molecular weight, a medium molecular weight, or can be an ultra-high molecular weight silicone. The silicone can be a polydimethylsiloxane. In one aspect, the silicone polymer can be added to the polymer composition as a master batch in combination with a carrier polymer. The carrier polymer, for instance, can be a polyester polymer such as a thermoplastic polyester polymer or a copolyester elastomer. Alternatively, the carrier polymer can be a polyolefin polymer, such as a polyethylene, or a polyamide polymer. When comprising a polymer or wax, the insulating adjuvant can be present in the polymer composition in an amount less than about 4% by weight, such as in an amount less than about 3.8% by weight, such as in an amount less than about 3.5% by weight, and in an amount greater than about 2.2% by weight, such as in an amount greater than about 2.5% by weight, such as in an amount greater than about 2.8% by weight. In one aspect, the amount of insulating adjuvant can be added to the composition so that the insulating adjuvant appears on the surface of molded articles made from the polymer composition.

In another aspect, the insulating adjuvant can be a mineral filler. The mineral filler can contain calcium, titanium, barium, magnesium, or combinations thereof. The mineral filler can be an oxide, a carbonate, a phosphate, or the like. In one aspect, the mineral filler can comprise a hydrotalcite. The mineral filler can be, in one embodiment, pentacalcium hydroxide tris (orthophosphate). The mineral filler can generally have a median particle size (d50) of less than about 10 microns, such as less than about 8 microns, such as less than about 6 microns, such as less than about 4 microns, and generally greater than about 0.5 microns, such as greater than about 1 micron, such as greater than about 2 microns.

The polymer composition can also contain reinforcing fibers, such as glass fibers. The reinforcing fibers can generally have an average fiber length of from about 1 mm to about 5 mm and can have an average fiber diameter of from about 8 microns to about 12 microns.

The polymer composition can also contain an organometallic compatibilizer. The organometallic compatibilizer, for instance, may be a titanate. One example of a titanate that may be used is titanium IV 2-propanolato,tris (dioctyl) phosphato-O. The organometallic compatibilizer can be present in the polymer composition generally in an amount from about 0.05% to about 2.5% by weight. The flame resistant polymer composition can also contain an ester of a carboxylic acid. For example, the ester may be formed by reacting montanic acid with a multifunctional alcohol. The multifunctional alcohol may be ethylene glycol or glycerine. The ester of a carboxylic acid can be present in the polymer composition generally in an amount from about 0.05% to about 8% by weight.

In one embodiment, the polymer composition can be formulated so as not to contain a carbodiimide.

The polymer composition can also contain a coloring agent. In one aspect, the coloring agent is a black pigment. The black pigment, for instance, can comprise bone char. The black pigment can also contain a phosphate salt, such as calcium phosphate. In one aspect the phosphate salt is calcium hydroxyphosphate.

The polymer composition of the present disclosure can have a melt flow rate of at least 3 cm³/10 min, such as greater than about 4 cm³/10 min, when tested at 250° C. and at a load of 2.16 kg.

In one embodiment, the present disclosure is directed to an electrical connector, such as a high-voltage connector, that comprises at least two opposing walls between which a passageway is defined for receiving a contact element. The contact element, for instance, can be a male conductive element or a female conductive element. In accordance with the present disclosure, the at least two opposing walls are formed from the polymer composition as described above.

Other features and aspects of the present disclosure are discussed in greater detail below.

### DEFINITIONS

As used herein, the flame resistant properties of a polymer are measured according to Underwriters Laboratories Test 94 according to the Vertical Burn Test. Test plaques can be made at different thicknesses for measuring flame resistance. A rating of V-0 indicates the best rating.

The melt flow rate of a polymer or polymer composition is measured according to ISO Test 1133 at a suitable temperature and load, such as at 250° C. and at a load of 2.16 kg or at a load of 5 kg.

The density of a polymer is measured according to ISO Test 1183 in units of g/cm³.

Average particle size (d50) is measured using light scattering, such as a suitable Horiba light scattering device.

The average molecular weight of a polymer is determined using the Margolies' equation.

Tensile modulus, tensile stress at yield, tensile strain at yield, tensile stress at 50% break, tensile stress at break, and tensile nominal strain at break are all measured according to ISO Test 527-2/1B.

Charpy impact strength at 23° C. is measured according to ISO Test 179/1eU.

Comparative tracking index is measured according to International Electrotechnical Commission Standard IEC-60112/3.

Surface Resistivity is determined in accordance with IEC 60093,

Water absorption is determined according to ISO Test 62 (2008). The test is conducted until saturation in water at 23° C.

Critical surface tension is measured according to ASTM Test D-2578 (2017) using solutions of 2-ethoxy ethanol and formamide.

Contact angle is measured against water according to ASTM Test D-5946 (2017).

Unless otherwise indicated, the year of any standardized test is the year of the most current version of the test.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of a battery pack for an electrical vehicle illustrating the top cover removed; the battery pack employing a high-voltage harness connection structure in one or more embodiments for connecting to other components of a vehicle;

FIG. 2 is a perspective view of one embodiment of a high-voltage connector in accordance with the present disclosure;

FIG. 3 is an alternative embodiment of a high-voltage connector in accordance with the present disclosure; and

FIG. 4 is an embodiment of an electric car incorporating the battery pack of FIG. 1.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a halogen-free, flame resistant polymer composition that has excellent electrical tracking resistance properties. Polymer compositions made in accordance with the present disclosure not only demonstrate superior flammability ratings when tested according to Underwriters Laboratories Tests and excellent electrical resistance properties but also have excellent mechanical properties, including polymer processing properties.

Polymer compositions of the present disclosure are particularly well suited for high voltage applications. The polymer composition of the present disclosure, for instance, is well suited for use in constructing high voltage automotive connectors that can meet high safety standards for flammability and electrical properties. In accordance with the present disclosure, the polymer composition is formulated in order to have dramatically improved electrical tracking resistance to ensure safe and faster charging of electric vehicles. For example, polymer compositions formulated in accordance with the present disclosure can have a comparative tracking index of at least 600 V in combination with a Vertical Burn Test rating of V-0 at only a thickness of 0.8 mm.

In general, the polymer composition of the present disclosure contains a suitable thermoplastic polymer, such as a polybutylene terephthalate polymer, combined with a flame retardant composition that may contain a metal phosphinate alone or optionally in combination with a nitrogen-containing synergist. In addition to a flame retardant composition, the polymer composition can also contain reinforcing fibers. In accordance with the present disclosure, the polymer composition also contains at least one insulating adjuvant. The insulating adjuvant is added to the polymer composition in order to improve electrical tracking resistance without compromising any of the other properties. The insulating adjuvant, for instance, can be a polymer, wax, mineral filler, or combination thereof. Polymers and waxes well suited for use in the polymer composition have a surface resistivity of greater than 1011 ohm, a water absorption of less than 2.5%, a critical surface tension of less than about 40 dynes/cm, a contact angle of greater than about 70°, and/or a melting point of less than about 222° C.

The polymer composition of the present disclosure is particularly well suited to manufacturing electrical components, such as high-voltage electrical connectors. Electrical connectors made in accordance with the present disclosure can have a variety of configurations within the scope of the disclosure. As an example, the electrical connector can define a plurality of passageways or spaces between opposing walls. The passageways can accommodate contact elements to facilitate electrical connections. The contact elements, for instance, can be in the form of a male contact element or a female contact element for connecting with an opposing connector.

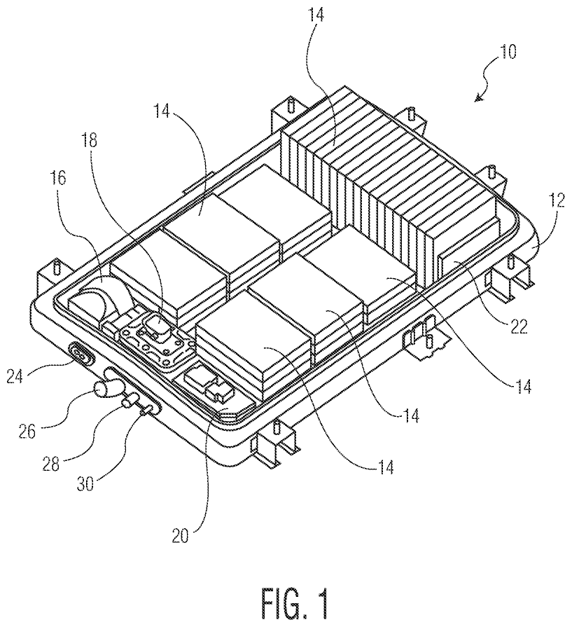

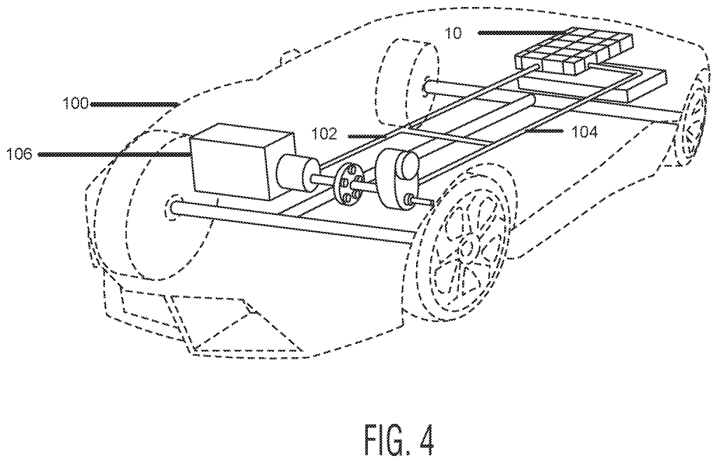

Referring to FIG. 1 and FIG. 4, for instance, one embodiment of a battery pack 10 installed in an electrical vehicle 100 is illustrated. The battery pack 10 includes a battery pack case 12. In the embodiment illustrated, only one portion of the battery pack case 12 is illustrated. The top of the battery pack case 12 has been removed in order to show the interior components.

The battery pack 10 can include a battery module 14, a temperature-adjusted air unit 16, a service disconnect switch 18 which is a high-voltage cut-off switch, a junction box 20, and a lithium ion battery controller 22.

The battery pack case 12 can be mounted in place at any suitable location within a vehicle. In order to connect the battery pack 10 to other components within a vehicle, the battery pack case 12 supports a refrigerant pipe connector terminal 24, a charging/discharging connector terminal 26, a heavy-electric connector terminal 28, and a weak electric connector terminal 30.

The battery module 14 can include a plurality of battery submodules. Each battery submodule is an assembly structure in which a plurality of battery cells are stacked on one another.

One or more high-voltage electric harnesses connect the battery pack 10 to an electric motor contained within the vehicle. For example, as shown in FIG. 4, battery pack 10 is connected to an electric motor 106 via wiring harness 102 and wiring harness 104. In addition to connectors to the battery pack 10, the electric motor of the vehicle can include converter to engine connectors, inverter to heater connectors, inverter to compressor connectors, charger to converter connectors, and the like. All of these components require connectors, particularly high-voltage connectors.

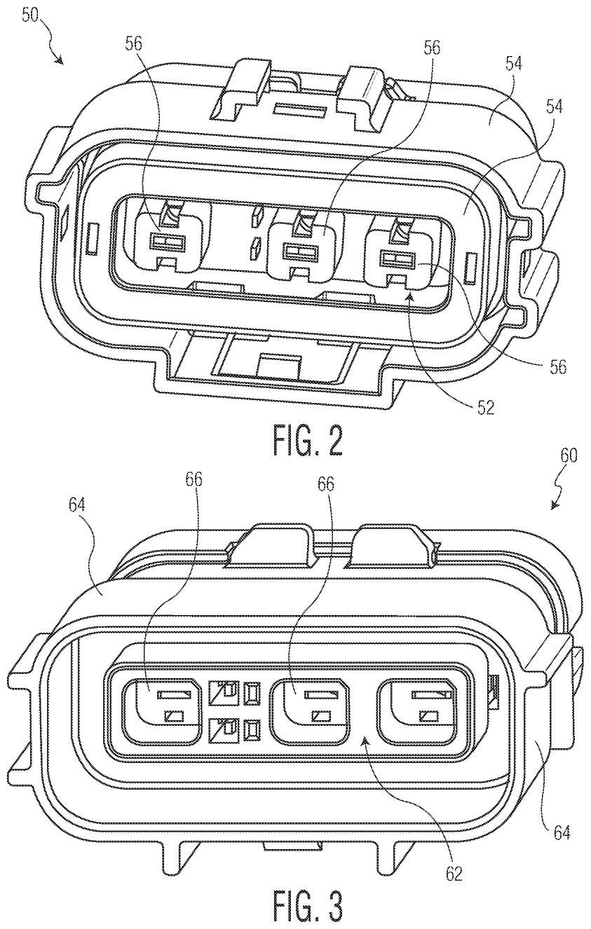

Referring to FIG. 2, one embodiment of a high-voltage connector 50 that may be made in accordance with the present disclosure is shown. The electrical connector 50 includes an insertion passageway 52 surrounded by opposing walls 54. The walls 54 accommodate a plurality of contact elements 56. The contact elements 56 are for making an electrical connection to an opposing connector. In the embodiment illustrated in FIG. 2, the contact elements 56 are male contacts that are to be inserted into opposing receptors.

Referring to FIG. 3, another connector 60 made in accordance with the present disclosure is shown. The connector 60 is for receiving and attaching to the connector 50 as shown in FIG. 2. The connector 60 includes an insertion passageway 62 surrounded by a plurality of opposing walls 64. The connector 60 includes a plurality of contact elements 66. The contact elements 66 are female connectors for receiving the male contact elements 56 from connector 50 as shown in FIG. 2.

In accordance with the present disclosure, the opposing walls 54 of the connector 50 and the opposing walls 64 of the connector 60 can be made from the polymer composition of the present disclosure. The polymer composition has excellent flame resistant properties. For example, when tested according to a Vertical Burn Test according to Underwriters Laboratories Test 94, the polymer composition can have a V-0 rating when tested at a thickness of 0.8 mm. In addition, the polymer composition can display a comparative tracking index (CTI) of at least 600 V.

The polymer composition also has excellent mechanical properties. For instance, the tensile modulus of the polymer composition can be greater than about 8,400 MPa, such as greater than about 9,000 MPa, such as greater than about 9,500 MPa, such as greater than about 10,000 MPa. The tensile modulus is generally less than about 18,000 MPa. The polymer composition can have a tensile stress at break of greater than about 90 MPa, such as greater than about 95 MPa, such as greater than about 100 MPa, and generally less than about 130 MPa. The polymer composition can also have a notched Charpy impact strength of greater than about 6 kJ/m², such as greater than about 6.5 kJ/m², such as greater than about 7 kJ/m², such as greater than about 7.5 kJ/m², and generally less than about 14 kJ/m². The polymer composition can have an unnotched Charpy impact strength of generally greater than about 50 kJ/m².

As described above, the polymer composition generally contains a thermoplastic polymer and particularly a polyester polymer. The polyesters which are suitable for use herein are derived from an aliphatic or cycloaliphatic diol, or mixtures thereof, containing from 2 to about 10 carbon atoms and an aromatic dicarboxylic acid, i.e., polyalkylene terephthalates. In one aspect, the polyester polymer comprises a polybutylene terephthalate polymer, and particularly a polybutylene terephthalate having a relatively high melt flow rate.

In one aspect, the polyester polymer, such as the polybutylene terephthalate polymer, contains a relatively minimum amount of carboxyl end groups. For instance, the polyester polymer can contain carboxyl end groups in an amount less than about 20 mmol/kg, such as less than about 18 mmol/kg, such as less than about 15 mmol/kg, and generally greater than about 1 mmol/kg. The amount of carboxyl end groups can be minimized on the polyester polymer using different techniques. For example, in one embodiment, the polyester polymer can be contacted with an alcohol, such as benzyl alcohol, for decreasing the amount of carboxyl end groups.

The polyester polymer or polybutylene terephthalate polymer can generally have a melt flow rate of greater than about 10 cm³/10 min, such as greater than about 30 cm³/10 min, such as greater than about 35 cm³/10 min, such as greater than about 40 cm³/10 min, and generally less than about 100 cm³/10 min, such as less than about 80 cm³/10 min, such as less than about 70 cm³/10 min, when tested at 250° C. and at a load of 2.16 kg.

The thermoplastic polymer such as a polybutylene terephthalate polymer is present in the polymer composition in an amount sufficient to form a continuous phase. For example, the thermoplastic polymer may be present in the polymer composition in an amount of at least about 35% by weight, such as in an amount of at least about 40% by weight, such as in an amount of at least 45% by weight, such as in an amount of at least about 50% by weight, such as at least about 55% by weight. The thermoplastic polymer is generally present in an amount less than about 80% by weight.

In accordance with the present disclosure, at least one thermoplastic polymer as described above is combined with a non-halogen flame retardant composition in accordance with the present disclosure. The flame retardant composition can contain a metal phosphinate optionally in combination with a nitrogen-containing synergist.

The metal phosphinate, for instance, may be a dialkyl phosphinate and/or a diphosphinate. The metal phosphinate may have one of the following chemical structures:

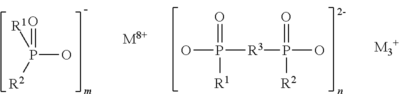

in which R¹, R² are the same or different and are each linear or branched C₁-C₆-alkyl; R³ is linear or branched C₁-C₁₀-alkylene, C₆-C₁₀-arylene, C₇-C₂₀-alkylarylene or C₇-C₂₀-arylalkylene; M is Mg, Ca, Al, Sb, Sn, Ge, Ti, Zn, Fe, Zr, Ce, Bi, Sr, Mn, Li, Na, K and/or a protonated nitrogen base; m is 1 to 4; n is 1 to 4; x is 1 to 4.

In one embodiment, the metal phosphinate is a metal dialkylphosphinate, such as aluminum diethylphosphinate. The metal phosphinate can be present in the polymer composition generally in an amount greater than about 5% by weight, such as in an amount greater than about 10% by weight, such as in an amount greater than about 12% by weight, such as in an amount greater than about 14% by weight, and generally in an amount less than about 30% by weight, such as in an amount less than about 25% by weight, such as in an amount less than about 20% by weight, such as in an amount less than about 19% by weight. In one embodiment, the metal phosphinate is present in the polymer composition in an amount from about 13% to about 19% by weight.

The nitrogen-containing synergist that may optionally be present in combination with the metal phosphinate can comprise a melamine. For instance, the nitrogen-containing synergist may comprise melamine cyanurate. Other melamine compounds that may be used include melamine polyphosphate, dimelamine polyphosphate, melem polyphosphate, melam polyphosphate, melon polyphosphate, and the like. Other nitrogen-containing synergists that may be used include benzoguanamine, tris (hydroxyethyl) isocyanurate, allantoin, glycoluril, guanidine, or mixtures thereof. In general, only small amounts of the nitrogen-containing synergists need to be present in the polymer composition. For instance, the nitrogen-containing synergists can be present in the polymer composition in an amount less than about 12% by weight, such as in an amount less than about 11% by weight, such as in an amount less than about 10% by weight, such as in an amount less than about 9% by weight, such as in an amount less than about 8.5% by weight, and generally in an amount greater than about 0.1% by weight, such as in an amount greater than about 2% by weight, such as in an amount greater than about 3% by weight, such as in an amount greater than about 4% by weight. In one embodiment, the polymer composition is free of nitrogen-containing synergists and only contains metal phosphinate.

In one aspect, the composition is formulated so as to be free of phosphite flame retardants, such as metal phosphites, including aluminum phosphite or sodium phosphite.

The polymer composition may also contain reinforcing fibers dispersed in the thermoplastic polymer matrix. Reinforcing fibers of which use may advantageously be made are mineral fibers, such as glass fibers or polymer fibers, in particular organic high-modulus fibers, such as aramid fibers.

These fibers may be in modified or unmodified form, e.g. provided with a sizing, or chemically treated, in order to improve adhesion to the plastic. Glass fibers are particularly preferred.

The reinforcing fibers, such as the glass fibers, can be coated with a sizing composition to protect the fibers and to improve the adhesion between the fiber and the matrix material. A sizing composition usually comprises silanes, film forming agents, lubricants, wetting agents, adhesive agents, optionally antistatic agents and plasticizers, emulsifiers and optionally further additives.

Specific examples of silanes are aminosilanes, e.g. 3-trimethoxysilylpropylamine, N-(2-aminoethyl)-3-aminopropyltrimethoxy-silane, N-(3-trimethoxysilanylpropyl)ethane-1,2-diamine, 3-(2-aminoethyl-amino)propyltrimethoxysilane, N-[3-(trimethoxysilyl)propyl]-1,2-ethane-diamine.

Film forming agents are for example polyvinylacetates, polyesters and polyurethanes.

The sizing composition applied to the reinforcing fibers can contain not only a silane sizing agent but can also contain a glycidyl ester type epoxy resin. For instance, the glycidyl ester type epoxy resin can be a monoglycidyl ester or a diglycidyl ester. Examples of glycidyl ester type epoxy resins that may be used include acrylic acid glycidyl ester, a methacrylic acid glycidyl ester, a phthalic acid diglycidyl ester, a methyltetrahydrophthalic acid diglycidyl ester, or mixtures thereof.

In one aspect, the sizing composition contains a silane, a glycidyl ester type epoxy resin, a second epoxy resin, a urethane resin, an acrylic resin, a lubricant, and an antistatic agent. The second type of epoxy resin, for instance, can be a bisphenol A type epoxy resin.

The reinforcing fibers may be compounded into the polymer matrix, for example in an extruder or kneader.

Fiber diameters can vary depending upon the particular fiber used and whether the fiber is in either a chopped or a continuous form. The fibers, for instance, can have a diameter of from about 5 μm to about 100 μm, such as from about 5 μm to about 50 μm, such as from about 5 μm to about 12 μm. The length of the fibers can vary depending upon the particular application. For instance, the fibers can have an average length of greater than about 0.5 mm, such as greater than about 1 mm, such as greater than about 1.5 mm, such as greater than about 2.5 mm. The length of the fibers can generally be less than about 8 mm, such as less than about 7 mm, such as less than about 5.5 mm, such as less than about 4 mm.

In general, reinforcing fibers are present in the polymer composition in amounts sufficient to increase the tensile strength of the composition. The reinforcing fibers, for example, can be present in the polymer composition in an amount greater than about 2% by weight, such as in an amount greater than about 5% by weight, such as in an amount greater than about 10% by weight, such as in an amount greater than about 15% by weight, such as in an amount greater than about 20% by weight. The reinforcing fibers are generally present in an amount less than about 55% by weight, such as in an amount less than about 50% by weight, such as in an amount less than about 45% by weight, such as in an amount less than about 40% by weight, such as in an amount less than about 35% by weight, such as in an amount less than about 30% by weight.

In accordance with the present disclosure, the polymer composition contains at least one insulating adjuvant. The insulating adjuvant can be a polymer or wax, a mineral filler, or combinations thereof. When the insulating adjuvant is a polymer or wax, the insulting adjuvant can have one or more various physical properties that have been found to improve the comparative tracking index. For instance, in one aspect, the polymeric insulating adjuvant can have a critical surface tension of less than about 40 dynes/cm, such as less than about 39 dynes/cm, such as less than about 38 dynes/cm, and greater than 5 dynes/cm. Alternatively or in addition, a polymeric insulating adjuvant can display a contact angle of greater than about 70°, such as greater than about 72°, such as greater than about 75°, such as greater than about 77°, such as greater than about 80°, and less than about 120°.

In one aspect, the polymer or wax can also have a relatively high surface resistivity. For example, the polymer or wax can display a surface resistivity of greater than about 10¹¹ ohm. The polymer or wax can also display a water absorption of less than about 2.5%. The polymer or wax can also have a melting point of less than about 222° C., such as less than about 218° C., such as less than about 210° C., such as less than about 205° C., such as less than about 200° C., such as less than about 195° C.

In one aspect, the insulating adjuvant comprises a polyamide polymer. The polyamide polymer can be an aliphatic polyamide polymer. In one aspect, the polyamide polymer can be a relatively long chain aliphatic polyamide polymer.

Polyamides generally have a CO—NH linkage in the main chain and are obtained by condensation of a diamine and a dicarboxylic acid, by ring opening polymerization of lactam, or self-condensation of an amino carboxylic acid. The polyamide may contain aliphatic repeating units derived from an aliphatic diamine, which can have greater than 6 carbon atoms, and particularly greater than 8 carbon atoms. Aliphatic polyamides particularly well suited for use as the insulating adjuvant are polyundecanamide or polyamide 11, polydodecanamide or polyamide 12, or mixtures thereof. Alternatively, the insulating adjuvant can be a semi-aromatic polyamide or an aromatic polyamide.

Alternatively, the insulating adjuvant can be a silicone polymer. The silicone polymer can have any suitable molecular weight. In one aspect, the silicone polymer can be an ultra-high molecular weight silicone. In general, the UHMW-Si can have an average molecular weight of greater than 100,000 g/mol, such as greater than about 200,000 g/mol, such as greater than about 300,000 g/mol, such as greater than about 500,000 g/mol and less than about 3,000,000 g/mol, such as less than about 2,000,000 g/mol, such as less than about 1,000,000 g/mol, such as less than about 500,000 g/mol, such as less than about 300,000 g/mol. Generally, the UHMW-Si can have a kinematic viscosity at 40° C. measured according to DIN 51562 of greater than 100,000 mm²s⁻¹, such as greater than about 200,000 mm²s⁻¹, such as greater than about 1,000,000 mm²s⁻¹, such as greater than about 5,000,000 mm²s⁻¹, such as greater than about 10,000,000 mm²s⁻¹, such as greater than about 15,000,000 mm²s⁻¹ and less than about 50,000,000 mm²s⁻¹, such as less than about 25,000,000 mm²s⁻¹, such as less than about 10,000,000 mm²s⁻¹, such as less than about 1,000,000 mm²s⁻¹, such as less than about 500,000 mm²s⁻¹, such as less than about 200,000 mm²s⁻¹.

The UHMW-Silicone may comprise a siloxane such as a polysiloxane or polyorganosiloxane. In one embodiment, the UHMW-Si may comprise a dialkylpolysiloxane such as a dimethylsiloxane, an alkylarylsiloxane such as a phenylmethylsiloxane, a polysilsesquioxane, or a diarylsiloxane such as a diphenylsiloxane, or a homopolymer thereof such as a polydimethylsiloxane or a polymethylphenylsiloxane, or a copolymer thereof with the above molecular weight and/or kinematic viscosity requirements. The polysiloxane or polyorganosiloxane may also be modified with a substituent such as an epoxy group, a hydroxyl group, a carboxyl group, an amino group or a substituted amino group, an ether group, or a meth (acryloyl) group in the end or main chain of the molecule. The UHMW-Si compounds may be used singly or in combination. Any of the above UHMW-Si compounds may be used with the above molecular weight and/or kinematic viscosity requirements.

In one aspect, the silicone polymer is incorporated into the polymer composition as a master batch. The master batch can contain the silicone polymer combined with a carrier polymer. In one aspect, the carrier polymer can comprise a polyester polymer, such as a polyester thermoplastic polymer or a copolyester elastomer. Thermoplastic polyester polymers that can serve as a carrier polymer include polybutylene terephthalate, polyethylene terephthalate, and the like. Alternatively, the carrier polymer can be a polyolefin polymer, such as a polyethylene polymer. The polyethylene polymer, for instance, can be a linear low density polyethylene polymer. The carrier polymer can also be a polyamide polymer, such as an aliphatic polyamide polymer. The carrier polymer can be present in the master batch in an amount greater than about 20% by weight, such as in an amount greater than about 30% by weight, such as in an amount greater than about 40% by weight, and in an amount less than about 70% by weight, such as in an amount less than about 60% by weight, such as in an amount less than about 50% by weight. The silicone polymer can be present in an amount from about 30% by weight to about 80% by weight, including all increments of 1% by weight therebetween. For example, the silicone polymer can be present in the master batch in an amount greater than 30% by weight, such as in an amount greater than about 40% by weight, such as in an amount greater than about 50% by weight, and in an amount less than about 80% by weight, such as in an amount less than about 70% by weight.

In another embodiment, the insulating adjuvant can be a wax, such as a higher alkane wax. The alkane wax, for instance, can have a carbon chain length of generally greater than about 16 carbon atoms, such as greater than about 18 carbon atoms, such as greater than about 20 carbon atoms, and less than about 70 carbon atoms, such as less than about 60 carbon atoms. In one aspect, the alkane contains a carbon chain having a carbon chain length of from about 20 carbon atoms to about 30 carbon atoms including mixtures thereof. In one particular aspect, the insulating adjuvant can be a paraffin wax.

When the insulating adjuvant is a polymer or wax, the polymer or wax can be present in the polymer composition in an amount sufficient for the polymer or wax to migrate to the surface of molded articles made from the polymer composition. The amount of the polymer or wax, however, is also minimized in order to prevent degradation of flame retardant properties. In one aspect, the polymer wax present in the polymer composition in an amount greater than about 0.5% by weight, such as in an amount greater than about 1% by weight, such as in an amount greater than about 1.5% by weight, such as in an amount greater than about 2% by weight, such as in an amount greater than about 2.2% by weight, such as in an amount greater than about 2.4% by weight, such as in an amount greater than about 2.6% by weight, and in an amount less than about 5% by weight, such as in an amount less than about 4.6% by weight, such as in an amount less than about 4.4% by weight, such as in an amount less than about 4.2% by weight, such as in an amount less than about 3.8% by weight, such as in an amount less than about 3.6% by weight, such as in an amount less than about 3.4% by weight, such as in an amount less than about 3.2% by weight.

In an alternative embodiment, the insulating adjuvant can be a mineral filler. The mineral filler can be added alone or in combination with a wax or polymer as described above. In one aspect, the mineral filler contains calcium, titanium, barium, magnesium, aluminum, zinc, or combinations thereof. The mineral filler, for instance, can be an oxide, a hydroxide, a carbonate, a sulfate, a phosphate, or the like. Examples of mineral fillers include a calcium phosphate, calcium carbonate, calcium oxide, magnesium oxide, barium sulfate, titanium dioxide, and the like. The mineral filler can also be a hydrotalcite or a hydroxyapatite.

Any suitable hydrotalcite may be used. Hydrotalcite can be a nonstoichiometric compound that, in one aspect, can be represented by a general formula: [Mg₁₋ₓAlₓ(OH)_{z}]^{x+}[(CO3)_{x/2}·m(H2O)]^{x-} and is an inorganic material having a layered crystal structure that can include a positively charged base layer and a negatively charged intermediate layer. In the one embodiment above, x represents a number in a range greater than 0 and less than or equal to 0.5, such as 0.33. Natural hydrotalcite can be represented by Mg6Al2(OH) 16CO3.4H20. One example of a synthesized hydrotalcite is Mg45Al2(OH) 13CO3.3.5H20. The hydrotalcite can have an average particle size (d50) of less than 8 microns, such as less than about 1 micron and greater than about 0.1 microns.

Any suitable hydroxyapatite can be incorporated into the composition. Calcium hydroxyapatite has the formula Ca₅(PO₄)₃OH. Calcium hydroxyapatite has its own, distinct crystal structure. In one aspect, the mineral filler may comprise pentacalcium hydroxide tris (orthophosphate). The hydrotalcite can have an average particle size (d50) of less than 10 microns, such as less than about 8 microns, such as less than about 6 microns, and greater than about 0.5 microns.

The mineral filler is incorporated into the polymer composition in an amount and in a manner that causes at least a portion of the mineral filler to be exposed on the surface of articles molded from the polymer composition. The mineral filler, for instance, can have a median particle size (D50) of greater than about 0.5 microns, such as greater than about 1 micron, such as greater than about 1.5 microns, such as greater than about 2 microns. The particle size of the mineral filler is generally less than about 15 microns, such as less than about 10 microns, such as less than about 8 microns, such as less than about 6 microns, such as less than about 5 microns.

One or more mineral fillers can be incorporated into the polymer composition in an amount generally greater than about 0.5% by weight, such as in an amount greater than about 1% by weight, such as in an amount greater than about 1.5% by weight, such as in an amount greater than about 2% by weight, such as in an amount greater than about 2.2% by weight, such as in an amount greater than about 2.4% by weight, such as in an amount greater than about 2.6% by weight, and in an amount less than about 5% by weight, such as in an amount less than about 4% by weight, such as in an amount less than about 3.8% by weight, such as in an amount less than about 3.6% by weight, such as in an amount less than about 3.4% by weight.

In addition to the flame retardant composition and the one or more insulating adjuvants, the polymer composition can also contain a fluoropolymer, such as a polytetrafluoroethylene powder. The fluoropolymer particles can have a relatively large particle size. For instance, the average particle size of the particles can be greater than about 100 microns, such as greater than about 200 microns, such as greater than about 300 microns, such as greater than about 350 microns, such as greater than about 375 microns, and less than about 800 microns, such as less than about 600 microns, such as less than about 500 microns, such as less than about 450 microns (ISO Test 13320). The fluoropolymer particles can have a bulk density of greater than about 300 g/L, such as greater than about 350 g/L, such as greater than about 400 g/L, such as greater than about 450 g/L, such as greater than about 470 g/L, and less than about 700 g/L, such as less than about 600 g/L, such as less than about 575 g/L, such as less than about 550 g/L, such as less than about 525 g/L (ISO Test 60). In one aspect, the fluoropolymer particles can have a density or specific gravity according to ISO Test 12086 of greater than about 2 g/cm³, such as greater than about 2.05 g/cm³, such as greater than about 2.1 g/cm³, such as greater than about 2.12 g/cm³, and less than 3 g/cm³, such as less than about 2.5 g/cm³, such as less than about 2.3 g/cm³, such as less than about 2.2 g/cm³, such as less than about 2.18 g/cm³.

It was discovered that very small amounts of fluoropolymer particles can be added to the polymer composition for creating beneficial effects, especially with respect to the flame retardant properties. For example, the fluoropolymer particles can be present in the polymer composition in an amount less than about 2% by weight, such as in an amount less than about 1% by weight, such as in an amount less than about 0.8% by weight, such as in an amount less than about 0.5% by weight, such as in an amount less than about 0.4% by weight, such as in an amount less than about 0.3% by weight, such as in an amount less than about 0.2% by weight, and in an amount greater than about 0.01% by weight, such as in an amount greater than about 0.05% by weight, such as in an amount greater than about 0.08% by weight.

The polymer composition can also contain an organometallic compatibilizer. The organometallic compatibilizer has been found to unexpectedly increase hydrolysis resistance and improve the flow properties of the polymer composition during polymer processing. In addition, the organometallic compatibilizer can provide various other benefits and advantages. For instance, the organometallic compatibilizer can provide anti-corrosion properties, increase the acid resistance of the polymer composition, and can improve the long-term aging properties of the polymer composition. In addition, the organometallic compatibilizer can serve as an intumescent flame retardant in certain applications.

The organometallic compatibilizer may comprise a monoalkoxy titanate. Other organometallic compounds that may be used include zirconates and aluminates. Specific examples of titanates that may be incorporated into the polymer composition include Titanium IV 2-propanolato, tris isooctadecanoato-O; Titanium IV bis 2-methyl-2-propenoato-O, isooctadecanoato-O 2-propanolato; Titanium IV 2-propanolato, tris(dodecyl)benzenesulfanato-O; Titanium IV 2-propanolato, tris(dioctyl)phosphato-O; Titanium IV, tris(2-methyl)-2-propenoato-O, methoxydiglycolylato; Titanium IV 2-propanolato, tris(dioctyl)pyrophosphato-O; Titanium IV, tris(2-propenoato-O), methoxydiglycolylato-O; Titanium IV 2-propanolato, tris(3,6-diaza)hexanolato, and mixtures thereof.

When present in the polymer composition, the organometallic compatibilizer can be included in an amount of generally greater than about 0.05% by weight, such as greater than about 0.1% by weight, such as greater than about 0.2% by weight, such as greater than about 0.28% by weight, and generally less than about 2.8% by weight, such as less than about 2.5% by weight, such as less than about 2.2% by weight, such as less than about 1.8% by weight, such as less than about 1.6% by weight, such as less than about 0.7% by weight.

In one embodiment, the polymer composition of the present disclosure can be formulated so as not to contain a carbodiimide.

The thermoplastic polymer composition of the present invention may also include a lubricant that constitutes from about 0.01 wt. % to about 2 wt. %, in some embodiments from about 0.1 wt. % to about 1 wt. %, and in some embodiments, from about 0.2 wt. % to about 0.5 wt. % of the polymer composition. The lubricant may be formed from a fatty acid salt derived from fatty acids having a chain length of from 22 to 38 carbon atoms, and in some embodiments, from 24 to 36 carbon atoms. Examples of such fatty acids may include long chain aliphatic fatty acids, such as montanic acid (octacosanoic acid), arachidic acid (arachic acid, icosanic acid, icosanoic acid, n-icosanoic acid), tetracosanoic acid (lignoceric acid), behenic acid (docosanoic acid), hexacosanoic acid (cerotinic acid), melissic acid (triacontanoic acid), erucic acid, cetoleic acid, brassidic acid, selacholeic acid, nervonic acid, etc. For example, montanic acid has an aliphatic carbon chain of 28 atoms and arachidic acid has an aliphatic carbon chain of 20 atoms. Due to the long carbon chain provided by the fatty acid, the lubricant has a high thermostability and low volatility. This allows the lubricant to remain functional during formation of the desired article to reduce internal and external friction, thereby reducing the degradation of the material caused by mechanical/chemical effects.

The fatty acid salt may be formed by saponification of a fatty acid wax to neutralize excess carboxylic acids and form a metal salt. Saponification may occur with a metal hydroxide, such as an alkali metal hydroxide (e.g., sodium hydroxide) or alkaline earth metal hydroxide (e.g., calcium hydroxide). The resulting fatty acid salts typically include an alkali metal (e.g., sodium, potassium, lithium, etc.) or alkaline earth metal (e.g., calcium, magnesium, etc.). Such fatty acid salts generally have an acid value (ASTM D 1386) of about 20 mg KOH/g or less, in some embodiments about 18 mg KOH/g or less, and in some embodiments, from about 1 to about 15 mg KOH/g. Particularly suitable fatty acid salts for use in the present invention are derived from crude montan wax, which contains straight-chain, unbranched monocarboxylic acids with a chain length in the range of C₂₈-C₃₂. Such montanic acid salts are commercially available from Clariant GmbH under the designations Licomont® CaV 102 (calcium salt of long-chain, linear montanic acids) and Licomont® NaV 101 (sodium salt of long-chain, linear montanic acids).

If desired, fatty acid esters may be used as lubricants. Fatty acid esters may be obtained by oxidative bleaching of a crude natural wax and subsequent esterification of the fatty acids with an alcohol. The alcohol typically has 1 to 4 hydroxyl groups and 2 to 20 carbon atoms. When the alcohol is multifunctional (e.g., 2 to 4 hydroxyl groups), a carbon atom number of 2 to 8 is particularly desired. Particularly suitable multifunctional alcohols may include dihydric alcohol (e.g., ethylene glycol, propylene glycol, butylene glycol, 1,3-propanediol, 1,4-butanediol, 1,6-hexanediol and 1,4-cyclohexanediol), trihydric alcohol (e.g., glycerol and trimethylolpropane), tetrahydric alcohols (e.g., pentaerythritol and erythritol), and so forth. Aromatic alcohols may also be suitable, such as o-, m- and p-tolylcarbinol, chlorobenzyl alcohol, bromobenzyl alcohol, 2,4-dimethylbenzyl alcohol, 3,5-dimethylbenzyl alcohol, 2,3,5-cumobenzyl alcohol, 3,4,5-trimethylbenzyl alcohol, p-cuminyl alcohol, 1,2-phthalyl alcohol, 1,3-bis(hydroxymethyl) benzene, 1,4-bis(hydroxymethyl)benzene, pseudocumenyl glycol, mesitylene glycol and mesitylene glycerol. Particularly suitable fatty acid esters for use in the present invention are derived from montanic waxes. Licowax® OP (Clariant), for instance, contains montanic acids partially esterified with butylene glycol and montanic acids partially saponified with calcium hydroxide. Thus, Licowax® OP contains a mixture of montanic acid esters and calcium montanate. Other montanic acid esters that may be employed include Licowax® E, Licowax® OP, and Licolub® WE 4 (all from Clariant), for instance, are montanic esters obtained as secondary products from the oxidative refining of raw montan wax. Licowax® E and Licolub®WE 4 contain montanic acids esterified with ethylene glycol or glycerine.

Other known waxes may also be employed in a lubricant. Amide waxes, for instance, may be employed that are formed by reaction of a fatty acid with a monoamine or diamine (e.g., ethylenediamine) having 2 to 18, especially 2 to 8, carbon atoms. For example, ethylenebisamide wax, which is formed by the amidization reaction of ethylene diamine and a fatty acid, may be employed. The fatty acid may be in the range from C₁₂ to C₃₀, such as from stearic acid (C₁₈ fatty acid) to form ethylenebisstearamide wax. Ethylenebisstearamide wax is commercially available from Lonza, Inc. under the designation Acrawax® C, which has a discrete melt temperature of 142° C. Other ethylenebisamides include the bisamides formed from lauric acid, palmitic acid, oleic acid, linoleic acid, linolenic acid, oleostearic acid, myristic acid and undecalinic acid. Still other suitable amide waxes are N-(2-hydroxyethyl)12-hydroxystearamide and N,N′-(ethylene bis)12-hydroxystearamide, which are commercially available from CasChem, a division of Rutherford Chemicals LLC, under the designations Paricin® 220 and Paricin® 285, respectively.

The polymer composition may also contain one or more coloring agents in an amount of from about 0.01% by weight to about 2% by weight. The coloring agent can comprise a pigment, a dye, or mixtures thereof.

Of particular advantage, it was discovered that a black pigment can be incorporated into the polymer composition, while still maintaining the comparative tracking index of 600 V or greater. In one aspect, the black pigment is a bone black pigment. The bone black pigment, for instance, can be produced by the destructive distillation of animal bones in the absence of oxygen to form bone char. The bone char can have an average particle size of from about 0.1 microns to about 0.8 microns, such as from about 0.3 microns to about 0.5 microns. The bone black pigment can comprise from about 7% to about 20% by weight carbon.

The bone black pigment can be present in the polymer composition generally in an amount greater than about 0.1% by weight, such as in an amount greater than about 0.3% by weight, such as in an amount greater than about 0.5% by weight, such as in an amount greater than about 0.7% by weight, such as in an amount greater than about 0.9% by weight, such as in an amount greater than about 1.1% by weight. The bone black pigment may be present in the polymer composition in an amount less than about 4% by weight, such as in an amount less than about 3% by weight, such as in an amount less than about 2.4% by weight, such as in an amount less than about 2% by weight, such as in an amount less than about 1.8% by weight, such as in an amount less than about 1.4% by weight, such as in an amount less than about 1.2% by weight, such as in an amount less than about 1% by weight.

Incorporating bone black pigment into the polymer composition of the present disclosure can also provide various functional benefits. For instance, bone char can render the polymer composition laser markable when molded into an article. Once exposed to laser light, for instance, bone char pigment can change in color, such as to a white color.

The polymer composition of the present disclosure can also contain carbon black. Carbon black can be added for further color enrichment. Carbon black can be present in the polymer composition generally in an amount from about 0.001% by weight to about 0.5% by weight, such as from about 0.01% by weight to about 0.3% by weight.

The polymer composition may also contain at least one stabilizer. The stabilizer may comprise an antioxidant, a light stabilizer such as an ultraviolet light stabilizer, a thermal stabilizer, and the like.

Sterically hindered phenolic antioxidant(s) may be employed in the composition. Examples of such phenolic antioxidants include, for instance, calcium bis(ethyl 3,5-di-tert-butyl-4-hydroxybenzylphosphonate) (Irganox® 1425); terephthalic acid, 1,4-dithio-,S,S-bis(4-tert-butyl-3-hydroxy-2,6-dimethylbenzyl) ester (Cyanox®) 1729); triethylene glycol bis(3-tert-butyl-4-hydroxy-5-methylhydrocinnamate); hexamethylene bis(3,5-di-tert-butyl-4-hydroxyhydrocinnamate (Irganox® 259); 1,2-bis(3,5,di-tert-butyl-4-hydroxyhydrocinnamoyl)hydrazide (Irganox® 1024); 4,4′-di-tert-octyldiphenamine (Naugalube® 438R); phosphonic acid, (3,5-di-tert-butyl-4-hydroxybenzyl)-,dioctadecyl ester (Irganox® 1093); 1,3,5-trimethyl-2,4,6-tris (3′,5′-di-tert-butyl-4′ hydroxybenzyl)benzene (Irganox® 1330); 2,4-bis(octylthio)-6-(4-hydroxy-3,5-di-tert-butylanilino)-1,3,5-triazine (Irganox® 565); isooctyl 3-(3,5-di-tert-butyl-4-hydroxyphenyl)propionate (Irganox®) 1135); octadecyl 3-(3,5-di-tert-butyl-4-hydroxyphenyl)propionate (Irganox® 1076); 3,7-bis(1,1,3,3-tetramethylbutyl)-10H-phenothiazine (Irganox® LO 3); 2,2′-methylenebis(4-methyl-6-tert-butylphenol)monoacrylate (Irganox® 3052); 2-tert-butyl-6-[1-(3-tert-butyl-2-hydroxy-5-methylphenyl)ethyl]-4-methylphenyl acrylate (Sumilizer® TM 4039); 2-[1-(2-hydroxy-3,5-di-tert-pentylphenyl)ethyl]-4,6-di-tert-pentylphenyl acrylate (Sumilizer® GS); 1,3-dihydro-2H-Benzimidazole (Sumilizer® MB); 2-methyl-4,6-bis[(octylthio)methyl]phenol (Irganox® 1520); N,N′-trimethylenebis-[3-(3,5-di-tert-butyl-4-hydroxyphenyl)propionamide (Irganox® 1019); 4-n-octadecyloxy-2,6-diphenylphenol (Irganox® 1063); 2,2′-ethylidenebis[4,6-di-tert-butylphenol] (Irganox® 129): N N′-hexamethylenebis(3,5-di-tert-butyl-4-hydroxyhydrocinnamamide) (Irganox® 1098); diethyl (3,5-di-tert-butyl-4-hydroxybenxyl)phosphonate (Irganox® 1222); 4,4′-di-tert-octyldiphenylamine (Irganox® 5057); N-phenyl-1-napthalenamine (Irganox® L 05); tris[2-tert-butyl-4-(3-ter-butyl-4-hydroxy-6-methylphenylthio)-5-methyl phenyl]phosphite (Hostanox® OSP 1); zinc dinonyidithiocarbamate (Hostanox® VP-ZNCS 1); 3,9-bis [1,1-diimethyl-2-[(3-tert-butyl-4-hydroxy-5-methylphenyl)propionyloxy]ethyl]-2,4,8,10-tetraoxaspiro[5.5] undecane (Sumilizer® AG80); pentaerythrityl tetrakis[3-(3,5-di-tert-butyl-4-hydroxyphenyl)propionate] (Irganox® 1010); ethylene-bis(oxyethylene)bis[3-(5-tert-butyl-4-hydroxy-m-tolyl)-propionate (Irganox® 245); 3,5-di-tert-butyl-4-hydroxytoluene (Lowinox BHT, Chemtura) and so forth.

Some examples of suitable sterically hindered phenolic antioxidants for use in the present composition are triazine antioxidants having the following general formula:

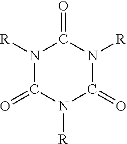

wherein, each R is independently a phenolic group, which may be attached to the triazine ring via a C₁ to C₅ alkyl or an ester substituent. Preferably, each R is one of the following formula (I)-(III):

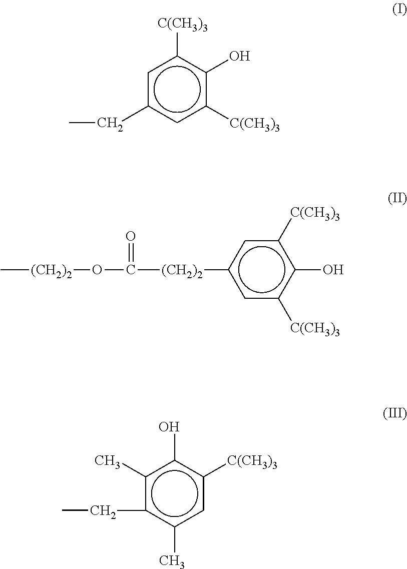

Commercially available examples of such triazine-based antioxidants may be obtained from American Cyanamid under the designation Cyanox® 1790 (wherein each R group is represented by the Formula III) and from Ciba Specialty Chemicals under the designations Irganox® 3114 (wherein each R group is represented by the Formula I) and Irganox® 3125 (wherein each R group is represented by the Formula II).

Sterically hindered phenolic antioxidants may constitute from about 0.01 wt. % to about 3 wt. %, in some embodiments from about 0.05 wt. % to about 1 wt. %, and in some embodiments, from about 0.05 wt. % to about 0.3 wt. % of the entire stabilized polymer composition. In one embodiment, for instance, the antioxidant comprises pentaerythrityl tetrakis [3-(3,5-di-tert-butyl-4-hydroxyphenyl)propionate.

Hindered amine light stabilizers (“HALS”) may be employed in the composition to inhibit degradation of the polyester composition and thus extend its durability. Suitable HALS compounds may be derived from a substituted piperidine, such as alkyl-substituted piperidyl, piperidinyl, piperazinone, alkoxypiperidinyl compounds, and so forth. For example, the hindered amine may be derived from a 2,2,6,6-tetraalkylpiperidinyl. Regardless of the compound from which it is derived, the hindered amine is typically an oligomeric or polymeric compound having a number average molecular weight of about 1,000 or more, in some embodiments from about 1000 to about 20,000, in some embodiments from about 1500 to about 15,000, and in some embodiments, from about 2000 to about 5000. Such compounds typically contain at least one 2,2,6,6-tetraalkylpiperidinyl group (e.g., 1 to 4) per polymer repeating unit.

Without intending to be limited by theory, it is believed that high molecular weight hindered amines are relatively thermostable and thus able to inhibit light degradation even after being subjected to extrusion conditions. One particularly suitable high molecular weight hindered amine has the following general structure:

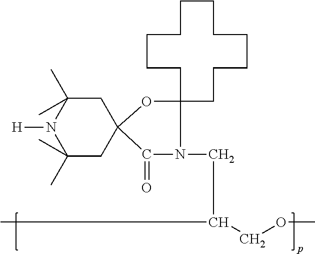

wherein, p is 4 to 30, in some embodiments 4 to 20, and in some embodiments 4 to 10. This oligomeric compound is commercially available from Clariant under the designation Hostavin® N30 and has a number average molecular weight of 1200.

Another suitable high molecular weight hindered amine has the following structure:

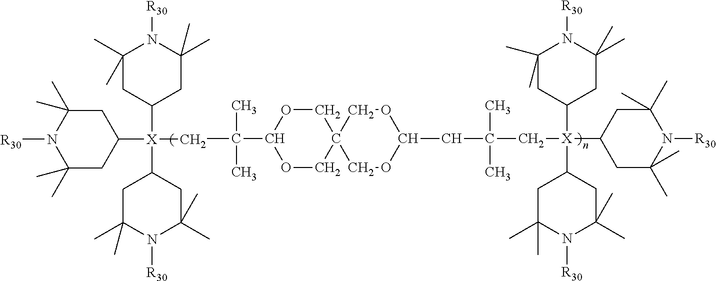

wherein, n is from 1 to 4 and R₃₀ is independently hydrogen or CH₃. Such oligomeric compounds are commercially available from Adeka Palmarole SAS (joint venture between Adeka Corp. and Palmarole Group) under the designation ADK STAB® LA-63 (R₃₀ is CH₃) and ADK STAB® LA-68 (R₃₀ is hydrogen).

Other examples of suitable high molecular weight hindered amines include, for instance, an oligomer of N-(2-hydroxyethyl)-2,2,6,6-tetramethyl-4-piperidinol and succinic acid (Tinuvin® 622 from Ciba Specialty Chemicals, MW=4000); oligomer of cyanuric acid and N,N-di(2,2,6,6-tetramethyl-4-piperidyl)-hexamethylene diamine; poly((6-morpholine-S-triazine-2,4-diyl)(2,2,6,6-tetramethyl-4-piperidinyl)-iminohexamethylene-(2,2,6,6-tetramethyl-4-piperidinyl)-imino) (Cyasorb® UV 3346 from Cytec, MW=1600); polymethylpropyl-3-oxy-[4(2,2,6,6-tetramethyl)-piperidinylysiloxane (Uvasil® 299 from Great Lakes Chemical, MW=1100 to 2500); copolymer of α-methylstyrene-N-(2,2,6,6-tetramethyl-4-piperidinyl) maleimide and N-stearyl maleimide; 2,4,8,10-tetraoxaspiro[5.5] undecane-3,9-diethanol tetramethyl-polymer with 1,2,3,4-butanetetracarboxylic acid; and so forth.

In addition to the high molecular hindered amines, low molecular weight hindered amines may also be employed in the composition. Such hindered amines are generally monomeric in nature and have a molecular weight of about 1000 or less, in some embodiments from about 155 to about 800, and in some embodiments, from about 300 to about 800.

Specific examples of such low molecular weight hindered amines may include, for instance, bis-(2,2,6,6-tetramethyl-4-piperidyl) sebacate (Tinuvin®) 770 from Ciba Specialty Chemicals, MW=481); bis-(1,2,2,6,6-pentamethyl-4-piperidinyl)-(3,5-ditert.butyl-4-hydroxybenzyl)butyl-propane dioate; bis-(1,2,2,6,6-pentamethyl-4-piperidinyl)sebacate; 8-acetyl-3-dodecyl-7,7,9,9-tetramethyl-1,3,8-triazaspiro-(4,5)-decane-2,4-dione, butanedioic acid-bis-(2,2,6,6-tetramethyl-4-piperidinyl) ester; tetrakis-(2,2,6,6-tetramethyl-4-piperidyl)-1,2,3,4-butane tetracarboxylate; 7-oxa-3,20-diazadispiro(5.1.11.2) heneicosan-20-propanoic acid, 2,2,4,4-tetramethyl-21-oxo, dodecyl ester; N-(2,2,6,6-tetramethyl-4-piperidinyl)-N′-amino-oxamide; o-t-amyl-o-(1,2,2,6,6-pentamethyl-4-piperidinyl)-monoperoxi-carbonate; β-alanine, N-(2,2,6,6-tetramethyl-4-piperidinyl), dodecylester; ethanediamide, N-(1-acetyl-2,2,6,6-tetramethylpiperidinyl)-N′-dodecyl; 3-dodecyl-1-(2,2,6,6-tetramethyl-4-piperidinyl)-pyrrolidin-2,5-dione; 3-dodecyl-1-(1,2,2,6,6-pentamethyl-4-piperidinyl)-pyrrolidin-2,5-dione; 3-dodecyl-1-(1-acetyl,2,2,6,6-tetramethyl-4-piperidinyl)-pyrrolidin-2,5-dione, (Sanduvar® 3058 from Clariant, MW=448.7); 4-benzoyloxy-2,2,6,6-tetramethylpiperidine; 1-[2-(3,5-di-tert-butyl-4-hydroxyphenylpropionyloxy)ethyl]-4-(3,5-di-tert-butyl-4-hydroxylphenyl propionyloxy)-2,2,6,6-tetramethyl-piperidine; 2-methyl-2-(2″,2″,6″,6″-tetramethyl-4″-piperidinylamino)-N-(2′,2′,6′,6′-tetra-methyl-4′-piperidinyl)propionylamide; 1,2-bis-(3,3,5,5-tetramethyl-2-oxo-piperazinyl)ethane; 4-oleoyloxy-2,2,6,6-tetramethylpiperidine; and combinations thereof. Other suitable low molecular weight hindered amines are described in U.S. Pat. No. 5,679,733 to Malik, et al.

The hindered amines may be employed singularly or in combination in any amount to achieve the desired properties, but typically constitute from about 0.01 wt. % to about 4 wt. % of the polymer composition.

UV absorbers, such as benzotriazoles or benzopheones, may be employed in the composition to absorb ultraviolet light energy. Suitable benzotriazoles may include, for instance, 2-(2-hydroxyphenyl)benzotriazoles, such as 2-(2-hydroxy-5-methylphenyl)benzotriazole; 2-(2-hydroxy-5-tert-octylphenyl)benzotriazole (Cyasorb® UV 5411 from Cytec); 2-(2-hydroxy-3,5-di-tert-butylphenyl)-5-chlorobenzo-triazole; 2-(2-hydroxy-3-tert-butyl-5-methylphenyl)-5-chlorobenzotriazole; 2-(2-hydroxy-3,5-dicumylphenyl) enzotriazole; 2,2′-methylenebis(4-tert-octyl-6-benzo-triazolylphenol); polyethylene glycol ester of 2-(2-hydroxy-3-tert-butyl-5-carboxyphenyl)benzotriazole; 2-[2-hydroxy-3-(2-acryloyloxyethyl)-5-methylphenyl]-benzotriazole; 2-[2-hydroxy-3-(2-methacryloyloxyethyl)-5-tert-butylphenyl]benzotriazole; 2-[2-hydroxy-3-(2-methacryloyloxyethyl)-5-tert-octylphenyl]benzotriazole; 2-[2-hydroxy-3-(2-methacryloyloxyethyl)-5-tert-butylphenyl]-5-chlorobenzotriazole; 2-[2-hydroxy-5-(2-methacryloyloxyethyl)phenyl]benzotriazole; 2-[2-hydroxy-3-tert-butyl-5-(2-methacryloyloxyethyl)phenyl]benzotriazole; 2-[2-hydroxy-3-tert-amyl-5-(2-methacryloyloxyethyl)phenyl]benzotriazole; 2-[2-hydroxy-3-tert-butyl-5-(3-methacryloyloxypropyl)phenyl]-5-chlorobenzotriazole; 2-[2-hydroxy-4-(2-methacryloyloxymethyl)phenyl]benzotriazole; 2-[2-hydroxy-4-(3-methacryloyloxy-2-hydroxypropyl)phenyl]benzotriazole; 2-[2-hydroxy-4-(3-methacryloyloxypropyl)phenyl]benzotriazole; and combinations thereof.

Exemplary benzophenone light stabilizers may likewise include 2-hydroxy-4-dodecyloxybenzophenone; 2,4-dihydroxybenzophenone; 2-(4-benzoyl-3-hydroxyphenoxy)ethyl acrylate (Cyasorb® UV 209 from Cytec); 2-hydroxy-4-n-octyloxy)benzophenone (Cyasorb® 531 from Cytec): 2,2′-dihydroxy-4-(octyloxy)benzophenone (Cyasorb® UV 314 from Cytec); hexadecyl-3,5-bis-tert-butyl-4-hydroxybenzoate (Cyasorb®) UV 2908 from Cytec); 2,2′-thiobis(4-tert-octylphenolato)-n-butylamine nickel(II) (Cyasorb® UV 1084 from Cytec); 3,5-di-tert-butyl-4-hydroxybenzoic acid, (2,4-di-tert-butylphenyl)ester (Cyasorb® 712 from Cytec); 4,4′-dimethoxy-2,2′-dihydroxybenzophenone (Cyasorb® UV 12 from Cytec); and combinations thereof.

When employed, UV absorbers may constitute from about 0.01 wt. % to about 4 wt. % of the entire polymer composition.

In one embodiment, the polymer composition may contain a blend of stabilizers that produce ultraviolet resistance and color stability. The combination of stabilizers may allow for products to be produced that have bright and fluorescent colors. In addition, bright colored products can be produced without experiencing significant color fading over time. In one embodiment, for instance, the polymer composition may contain a combination of a benzotriazole light stabilizer and a hindered amine light stabilizer, such as an oligomeric hindered amine.

Organophosphorus compounds may be employed in the composition that serve as secondary antioxidants to decompose peroxides and hydroperoxides into stable, non-radical products. Trivalent organophosphorous compounds (e.g., phosphites or phosphonites) are particularly useful in the stabilizing system of the present invention. Monophosphite compounds (i.e., only one phosphorus atom per molecule) may be employed in certain embodiments of the present invention. Preferred monophosphites are aryl monophosphites contain C₁ to C₁₀ alkyl substituents on at least one of the aryloxide groups. These substituents may be linear (as in the case of nonyl substituents) or branched (such as isopropyl or tertiary butyl substituents). Non-limiting examples of suitable aryl monophosphites (or monophosphonites) may include triphenyl phosphite; diphenyl alkyl phosphites; phenyl dialkyl phosphites; tris (nonylphenyl) phosphite (Weston™ 399, available from GE Specialty Chemicals); tris(2,4-di-tert-butylphenyl) phosphite (Irgafos®) 168, available from Ciba Specialty Chemicals Corp.); bis(2,4-di-tert-butyl-6-methylphenyl)ethyl phosphite (Irgafos®) 38, available from Ciba Specialty Chemicals Corp.); and 2,2′,2″-nitrilo[triethyltris(3,3′5,5′-tetra-tert-butyl-1,1′-biphenyl-2,2′-diyl) phosphate (Irgafos® 12, available from Ciba Specialty Chemicals Corp.). Aryl diphosphites or diphosphonites (i.e., contains at least two phosphorus atoms per phosphite molecule may also be employed in the stabilizing system and may include, for instance, distearyl pentaerythritol diphosphite, diisodecyl pentaerythritol diphosphite, bis(2,4 di-tert-butylphenyl) pentaerythritol diphosphite (Irgafos 126 available from Ciba); bis(2,6-di-tert-butyl-4-methylpenyl)pentaerythritol diphosphite; bisisodecyloxypentaerythritol diphosphite, bis(2,4-di-tert-butyl-6-methylphenyl)pentaerythritol diphosphite, bis(2,4,6-tri-tert-butylphenyl)pentaerythritol diphosphite, tetrakis(2,4-di-tert-butylphenyl)4,4′-biphenylene-diphosphonite (Sandostab™ P-EPQ, available from Clariant) and bis(2,4-dicumylphenyl)pentaerythritol diphosphite (Doverphos®) S-9228).

Organophosphorous compounds may constitute from about 0.01 wt. % to about 2 wt. %, in some embodiments from about 0.05 wt. % to about 1 wt. %, and in some embodiments, from about 0.1 wt. % to about 0.5 wt. % of the polymer composition.

In addition to the above components, the polymer composition may include various other ingredients. As described above the composition may contain one or more coloring agents. Coloring agents that may be used instead of or in addition to a black pigment include any desired inorganic pigments, such as titanium dioxide, ultramarine blue, cobalt blue, and other organic pigments and dyes, such as phthalocyanines, anthraquinones, and the like. Other colorants include various other polymer-soluble dyes. The colorants can generally be present in the composition in an amount up to about 2 percent by weight.

To help achieve excellent resistivity values, the composition can be generally free of conventional materials having a high degree of electrical conductivity. For example, the polymer composition may be generally free of electrically conductive fillers having an intrinsic volume resistivity of less than about 1 ohm-cm, in some embodiments about less than about 0.1 ohm-cm, and in some embodiments, from about 1×10⁻⁸ to about 1×10⁻² ohm-cm, such as determined at a temperature of about 20° C. Examples of such electrically conductive fillers may include, for instance, electrically conductive carbon materials such as, graphite, electrically conductive carbon black, carbon fibers, graphene, carbon nanotubes, etc.; metals (e.g., metal particles, metal flakes, metal fibers, etc.); ionic liquids; and so forth. While it is normally desired to minimize the presence of such electrically conductive materials, they may nevertheless be present in a relatively small percentage in certain embodiments, such as in an amount of about 5 wt. % or less, in some embodiments about 2 wt. % or less, in some embodiments about 1 wt. % or less, in some embodiments about 0.5 wt. % or less, and in some embodiments, from about 0.001 wt. % to about 0.2 wt. % of the polymer composition.

The compositions of the present disclosure can be compounded and formed into polymer articles using any technique known in the art. For instance, the respective composition can be intensively mixed to form a substantially homogeneous blend. The blend can be melt kneaded at an elevated temperature, such as a temperature that is higher than the melting point of the polymer utilized in the polymer composition but lower than the degradation temperature. Alternatively, the respective composition can be melted and mixed together in a conventional single or twin screw extruder. Preferably, the melt mixing is carried out at a temperature ranging from 150 to 300° C., such as from 200 to 280° C., such as from 220 to 270° C. or 240 to 260° C. However, such processing should be conducted for each respective composition at a desired temperature to minimize any polymer degradation.

After extrusion, the compositions may be formed into pellets. The pellets can be molded into polymer articles by techniques known in the art such as injection molding, thermoforming, blow molding, rotational molding and the like. According to the present disclosure, the polymer articles demonstrate excellent tribological behavior and mechanical properties. Consequently, the polymer articles can be used for several applications where low wear and excellent gliding properties are desired.

Of particular advantage, flame resistant polymer compositions can be formulated in accordance with the present disclosure with excellent flow properties. For example, when tested according to ISO Test 1133 at a temperature of 250° C. and at a load 2.16 kg, the overall polymer composition can have a melt flow rate of greater than about 3 cm³/10 min, such as greater than about 4 cm³/10 min, such as greater than about 5 cm³/10 min, such as greater than about 6 cm³/10 min, such as greater than about 7 cm³/10 min, such as greater than about 8 cm³/10 min, such as greater than about 9 cm³/10 min, such as greater than about 10 cm³/10 min. The melt flow rate is generally less than about 50 cm³/10 min.

The present disclosure may be better understood with reference to the following example.

### Example

Various polymer compositions were formulated in accordance with the present disclosure and tested for various properties. The following formulations were produced and the following results were obtained.

| | Sample | Sample | Sample | Sample | Sample | Sample | Sample |
|---|---|---|---|---|---|---|---|
| | No. 1 | No. 2 | No. 3 | No. 4 | No. 5 | No. 6 | No. 7 |
| polybutylene terephthalate | | 47.5 | 48.5 | | 52.5 | | |
| (MVR 62) cm3/10 min | | | | | | | |
| polybutylene terephthalate | 47.6 | | | 52.9 | | 47.6 | 47.6 |
| (MVR 38) cm3/10 min | | | | | | | |
| glass fibers (13 micron | 25.0 | 25.0 | 25.0 | 25.0 | 25.0 | 25.0 | 25.0 |
| diameter) | | | | | | | |
| polybutylene terephthalate | 1.5 | 1.5 | 1.5 | 1.5 | 1.5 | 1.5 | 1.5 |
| blending aid | | | | | | | |
| ester of montanic acids | 0.3 | 0.3 | 0.3 | 0.3 | 0.3 | 0.3 | 0.3 |
| with a polyol | | | | | | | |
| Pentaerythritol tetrakis(3- | 0.1 | 0.1 | 0.1 | 0.1 | 0.1 | 0.1 | 0.1 |
| (3,5-di-tert-butyl-4- | | | | | | | |
| hydroxyphenyl)propionate) | | | | | | | |
| Bis-(2,4-di-tert.butyl- | 0.2 | 0.2 | 0.2 | 0.2 | 0.2 | 0.2 | 0.2 |
| phenol) pentaerythritol | | | | | | | |
| diphosphite | | | | | | | |
| UHMW Si and copolyester | 3.0 | 3.0 | 3.0 | | | | |
| elastomer (1:1 ratio) | | | | | | | |
| Polyamide 11 | | | | | | 3.0 | |
| copolyester elastomer | | | | | | | 3.0 |
| titanate coupling agent | 0.3 | 0.3 | 0.3 | | 0.3 | 0.3 | 0.3 |
| polytetrafluoroethylene | | 0.1 | 0.1 | | 0.1 | | |
| particles | | | | | | | |
| Melamine poly(zinc | | | | 6.7 | 6.7 | | |
| phosphate) | | | | | | | |
| Melamine | | | | | | | |
| poly(magnesium | | | | | | | |
| phosphate) | | | | | | | |
| aluminum | 18.0 | 18.0 | 15.0 | 13.3 | 13.3 | 18.0 | 18.0 |
| diethylphosphonate | | | | | | | |
| (DEPAL) | | | | | | | |
| melamine cyanurate | 4.0 | 4.0 | 6.0 | | | 4.0 | 4.0 |
| Total (%) | 100.0 | 100.0 | 100.0 | 100.0 | 100.0 | 100.0 | 100.0 |

| | | Sample | Sample | Sample | Sample | Sample | Sample | Sample |
|---|---|---|---|---|---|---|---|---|
| Property | Units | No. 1 | No. 2 | No. 3 | No. 4 | No. 5 | No. 6 | No. 7 |
| MVR [250° C./5 kg] | cm³/10 | 11 | 10 | 13.5 | 19 | 20 | 6.5 | 8 |
| | min | | | | | | | |
| Tensile modulus (23° C.) | MPa | 9055 | 8880 | 8800 | 9910 | 9850 | 9690 | 9655 |
| Tensile strength (23° C.) | MPa | 90 | 89 | 90 | 109 | 104 | 105 | 103 |
| Strain at break (23° C.) | % | 2.3 | 2.2 | 2.2 | 2.1 | 1.9 | 1.9 | 1.9 |
| Charpy notched (23° C.) | KJ/m² | 8 | 8 | 8 | 8 | 7.5 | 7.5 | 7.5 |
| Charpy un-notched | KJ/m² | 34.5 | 32 | 33 | 40 | 38 | 36 | 38.5 |
| (23° C.) | | | | | | | | |
| Vertical burning [1.6 mm] | Rating | V0 | V0 | V0 | V0 | V0 | V0 | V0 |
| Vertical burning [0.8 mm] | Rating | V1 | V0 | V0 | V0 | V0 | V0 | V1 |
| Comparative tracking | V | 600 | 600 | 600 | 550 | 550 | 600 | 600 |
| index | | | | | | | | |

| | Sample | Sample | Sample | Sample | Sample |
|---|---|---|---|---|---|
| | No. 8 | No. 9 | No. 10 | No. 11 | No. 12 |
| polybutylene terephthalate | 48.5 | 48.6 | 48.6 | 48.6 | 48.6 |
| (MVR 62) cm3/10 min | | | | | |
| glass fibers (13 micron | 25.0 | 25.0 | 25.0 | 25.0 | 25.0 |
| diameter) | | | | | |
| polybutylene terephthalate | 1.5 | 1.5 | 1.5 | 1.5 | 1.5 |
| blending aid | | | | | |
| ester of montanic acids | 0.3 | 0.3 | 0.3 | 0.3 | 0.3 |
| with a polylyol | | | | | |
| Pentaerythritol tetrakis(3- | 0.1 | 0.1 | 0.1 | 0.1 | 0.1 |
| (3,5-di-tert-butyl-4- | | | | | |
| hydroxyphenyl)propionate) | | | | | |
| Bis-(2,4-di-tert.butyl- | 0.2 | 0.2 | 0.2 | 0.2 | 0.2 |
| phenol) pentaerythritol | | | | | |
| diphosphite | | | | | |
| polyamide 11 | 3.0 | 3.0 | | | |
| Eurelon 975 copolyamide | | | 3.0 | | |
| (softening point 171- | | | | | |
| 181° C.; melt viscosity 9-13 | | | | | |
| Pa · s @ 230° C.; amine | | | | | |
| value less than 5 | | | | | |
| mgKOH/g) | | | | | |
| Polyamide 12 | | | | 3.0 | |
| Polyamide 6 | | | | | 3.0 |
| titanate coupling agent | 0.3 | 0.3 | 0.3 | 0.3 | 0.3 |
| polytetrafluoroethylene | 0.1 | | | | |
| particles | | | | | |
| aluminum | 15.0 | 15.0 | 15.0 | 15.0 | 15.0 |
| diethylphosphonate | | | | | |
| (DEPAL) | | | | | |
| melamine cyanurate | 6.0 | 6.0 | 6.0 | 6.0 | 6.0 |
| Total (%) | 100.0 | 100.0 | 100.0 | 100.0 | 100.0 |

| | | Sample | Sample | Sample | Sample | Sample |
|---|---|---|---|---|---|---|
| Property | Units | No. 8 | No. 9 | No. 10 | No. 11 | No. 12 |
| MVR [250° C./5 kg] | cm³/10 | 10.7 | 4.3 | 16 | 15 | 20.5 |
| | min | | | | | |
| Tensile modulus | MPa | 9800 | 10160 | 10050 | 9890 | 9915 |
| (23° C.) | | | | | | |
| Tensile strength | MPa | 102 | 101 | 91.5 | 99 | 95 |
| (23° C.) | | | | | | |
| Strain at break (23° C.) | % | 1.7 | 1.8 | 1.6 | 1.9 | 1.7 |
| Vertical burning [1.6 mm] | Rating | V0 | V0 | V0 | V0 | V0 |
| Vertical burning [0.8 mm] | Rating | V0 | V1 | V0 | V0 | V0 |
| Comparative tracking | V | 600 | 600 | 550 | 600 | 550 |
| index | | | | | | |

| | Sample | Sample | Sample | Sample | Sample |
|---|---|---|---|---|---|
| | No. 13 | No. 14 | No. 15 | No. 16 | No. 17 |
| polybutylene terephthalate (MVR | 48.0 | 48.0 | 48.6 | 48.6 | 48.6 |
| 62) cm3/10 min | | | | | |
| glass fibers (13 micron diameter) | 26.0 | 26.0 | 25.0 | 25.0 | 25.0 |
| polybutylene terephthalate | 2.0 | 2.0 | 1.5 | 1.5 | 1.5 |
| blending aid | | | | | |
| ester of montanic acids with a | 0.3 | 0.3 | 0.3 | 0.3 | 0.3 |
| polylyol | | | | | |
| Pentaerythritol tetrakis(3-(3,5-di- | 0.1 | 0.1 | 0.1 | 0.1 | 0.1 |
| tert-butyl-4- | | | | | |
| hydroxyphenyl)propionate) | | | | | |
| Bis-(2,4-di-tert.butyl-phenol) | 0.2 | 0.2 | 0.2 | 0.2 | 0.2 |
| pentaerythritol diphosphite | | | | | |
| UHMW SI and copolyester | | | 3.0 | 3.0 | |
| elastomer (1:1) | | | | | |
| Polyamide 12 | | | | | 3.0 |
| Calcium hydroxyapatite (d50-3.1 | 3.0 | | | | |
| microns) | | | | | |
| Calcium hydroxyapatite (d50-4.0 | | 3.0 | | | |
| microns) | | | | | |
| polytetrafluoroethylene particles | 0.1 | 0.1 | | | |
| titanate coupling agent | 0.3 | 0.3 | 0.3 | 0.3 | 0.3 |
| DEPAL combined with | | | | 17.0 | 17.0 |
| phosphonic acid, aluminum salt | | | | | |
| aluminum diethylphosphonate | 13.33 | 13.33 | 15.0 | | |
| (DEPAL) | | | | | |
| melamine cyanurate | 6.67 | 6.67 | 6.0 | 4.0 | 4.0 |
| Total (%) | 100.0 | 100.0 | 100.0 | 100.0 | 100.0 |

| | | Sample | Sample | Sample | Sample | Sample |
|---|---|---|---|---|---|---|
| Property | Units | No. 13 | No. 14 | No. 15 | No. 16 | No. 17 |
| MVR [250° C./5 kg] | cm³/10 min | 13 | 13 | 13.5 | 25 | 24 |
| Tensile modulus (23° C.) | MPa | 10530 | 10535 | 9120 | 8500 | 9600 |
| Tensile strength (23° C.) | MPa | 106 | 105 | 95 | 94 | 100 |
| Strain at break (23° C.) | % | 2 | 2 | 2 | 2.4 | 1.9 |
| Vertical burning [1.6 mm] | Rating | V0 | V0 | V0 | V0 | V0 |
| Vertical burning [0.8 mm] | Rating | V0 | V0 | V1 | V1 | V1 |
| Comparative tracking index | V | 600 | 600 | 600 | 600 | 600 |

| | Sample | Sample | Sample | Sample | Sample |
|---|---|---|---|---|---|
| | No. 18 | No. 19 | No. 20 | No. 21 | No. 22 |
| polybutylene terephthalate (MVR | 48.0 | 43.0 | 48.0 | 48.0 | 48.0 |
| 62) cm3/10 min | | | | | |
| glass fibers (13 micron diameter) | 26.0 | 26.0 | 25.0 | 25.0 | 25.0 |
| polybutylene terephthalate | 2.0 | 2.0 | 1.5 | 1.5 | 1.5 |
| blending aid | | | | | |
| ester of montanic acids with a | 0.3 | 0.3 | 0.3 | 0.3 | 0.3 |
| polylyol | | | | | |
| Pentaerythritol tetrakis(3-(3,5-di- | 0.1 | 0.1 | 0.1 | 0.1 | 0.1 |
| tert-butyl-4- | | | | | |
| hydroxyphenyl)propionate) | | | | | |
| Bis-(2,4-di-tert.butyl-phenol) | 0.2 | 0.2 | 0.2 | 0.2 | 0.2 |
| pentaerythritol diphosphite | | | | | |
| Polyamide 11 | | | | 3.0 | 3.0 |
| Calcium hydroxyapatite (d50-3.1 | | 3.0 | 3.0 | | |
| microns) | | | | | |
| Calcium hydroxyapatite (d50-4.0 | 3.0 | | | | |
| microns) | | | | | |
| polytetrafluoroethylene particles | 0.1 | 0.1 | 0.1 | 0.1 | 0.1 |
| titanate coupling agent | 0.3 | 0.3 | 0.3 | 0.3 | 0.3 |
| DEPAL combined with | | | 17.0 | | 17.0 |
| phosphonic acid, aluminum salt | | | | | |
| aluminum diethylphosphonate | 13.33 | 13.33 | | 15.0 | |
| (DEPAL) | | | | | |
| melamine cyanurate | 6.67 | 6.67 | 4.0 | 6.0 | 4.0 |
| Bone Black Pigment in | | 5.0 | | | |
| masterbatch-21 wt. % pigment | | | | | |
| and 79 wt % PBT | | | | | |
| Total (%) | 100.0 | 100.0 | 100.0 | 100.0 | 100.0 |

| | | Sample | Sample | Sample | Sample | Sample |
|---|---|---|---|---|---|---|
| Property | Units | No. 18 | No. 19 | No. 20 | No. 21 | No. 22 |
| MVR [250° C./5 kg] | cm³/10 min | 15 | 13 | 16 | 11.5 | 22.5 |
| Tensile modulus (23° C.) | MPa | 10715 | 11025 | 10200 | 9730 | 9510 |
| Tensile strength (23° C.) | MPa | 105 | 104 | 101 | 101 | 102 |
| Strain at break (23° C.) | % | 2 | 1.8 | 1.9 | 1.9 | 2.1 |
| Vertical burning [1.6 mm] | Rating | V0 | V0 | V0 | V0 | V0 |
| Vertical burning [0.8 mm] | Rating | V0 | V0 | V0 | V0 | V0 |
| Comparative tracking index | V | 600 | 600 | 600 | 600 | 600 |
| Charpy Notched (23° C.) | KJ/m2 | 7.6 | 7.2 | 7.5 | 7.5 | 8 |
| Charpy Unnotched (23° C.) | KJ/m2 | 37 | 33 | 35 | 35 | 38 |

As shown above, Sample Nos. 2, 3, 6, 8, 11, 13,14 and 18 through 22 demonstrated a Vertical Burn Rating of V-0 at a thickness of only 0.8 mm while also demonstrating a Comparative Tracking Index of 600 V.

In view of the foregoing description and examples, the present disclosure provides the following embodiments.

Embodiment 1: A polymer composition comprising:
a thermoplastic polymer comprising a polybutylene terephthalate polymer, the thermoplastic polymer being present in the polymer composition in an amount greater than about 35% by weight;
a flame retardant composition contained within the polymer composition, the flame retardant composition comprising a non-halogen flame retardant, the non-halogen flame retardant comprising a metal phosphinate, the non-halogen flame retardant being present in the polymer composition in an amount of at least about 10% by weight;
reinforcing fibers dispersed throughout a polymer matrix formed from the thermoplastic polymer;
an insulating adjuvant comprising:
   (a) a polymer or wax having a critical surface tension of less than about 40 dynes/cm;
   (b) a mineral filler containing calcium, titanium, barium, magnesium, or combinations thereof; or
   (c) mixtures thereof;
      and wherein the insulating adjuvant is present in the polymer composition in an amount less than about 5% by weight; and
wherein the polymer composition displays a comparative tracking index of at least 600 V and when tested according to a Vertical Burn Test according to Underwriters Laboratories Test 94, the polymer composition displays a rating of V-0 when tested at a thickness of 0.8 mm.

Embodiment 2: A polymer composition as defined in embodiment 1, wherein the insulating adjuvant comprises a polymer or wax having a critical surface tension of less than about 39 dynes/cm, such as less than about 38 dynes/cm.

Embodiment 3: A polymer composition as defined in any of the preceding embodiments, wherein the insulating adjuvant comprises a polymer or wax having a contact angle of greater than about 70°, such as greater than about 72°, such as greater than about 75°, such as greater than about 77°, such as greater than about 80°.

Embodiment 4: A polymer composition as defined in any of the preceding embodiments, wherein the insulating adjuvant comprises a polymer or wax having a surface resistivity of greater than 1011 ohm and a water absorption of less than 2.5%;

Embodiment 5: A polymer composition as defined in any of the preceding embodiments, wherein the insulating adjuvant comprises a polymer or wax having a melting point of less than about 222° C., such as less than about 218° C., such as less than about 205° C., such as less than about 200° C., such as less than about 195° C.

Embodiment 6: A polymer composition as defined in any of the preceding embodiments, wherein the insulating adjuvant comprises an aliphatic polyamide polymer.

Embodiment 7: A polymer composition as defined in any of the preceding embodiments, wherein the insulating adjuvant comprises polyamide 11.

Embodiment 8: A polymer composition as defined in any of the preceding embodiments, wherein the insulating adjuvant comprises polyamide 12.

Embodiment 9: A polymer composition as defined in embodiment 1, wherein the insulating adjuvant comprises a silicone and is present in the polymer composition in an amount from about 0.3% by weight to about 4% by weight.

Embodiment 10: A polymer composition as defined in embodiment 9, wherein the silicone comprises a polydimethylsiloxane.

Embodiment 11: A polymer composition as defined in embodiment 9 or 10, wherein the silicone is added to the polymer composition as a masterbatch comprising the silicone combined with a carrier polymer.

Embodiment 12: A polymer composition as defined in embodiment 11, wherein the carrier polymer comprises a thermoplastic polyester polymer or a copolyester elastomer.

Embodiment 13: A polymer composition as defined in embodiment 11, wherein the carrier polymer comprises a polyolefin.

Embodiment 14: A polymer composition as defined in embodiment 11, wherein the carrier polymer comprises a polyamide.

Embodiment 15: A polymer composition as defined in any of the preceding embodiments, wherein the polybutylene terephthalate polymer has a melt flow rate of greater than about 20 cm³/10 min, such as greater than about 30 cm³/10 min, such as greater than about 35 cm³/10 min, and less than about 100 cm³/10 min, such as less than about 80 cm³/10 min, such as less than about 70 cm³/10 min.

Embodiment 16: A polymer composition as defined in any of the preceding embodiments, wherein the polymer composition does not contain a carbodiimide.

Embodiment 17: A polymer composition as defined in embodiment 1, wherein the thermoplastic polymer further comprises a bone black pigment.

Embodiment 18: A polymer composition as defined in any of the preceding embodiments, wherein the reinforcing fibers comprise glass fibers.

Embodiment 19: A polymer composition as defined in embodiment 18, wherein the reinforcing fibers have an average fiber length of from about 1 mm to about 5 mm and have an average fiber diameter of from about 8 microns to about 15 microns.

Embodiment 20: A flame resistant polymer composition as defined in any of the preceding embodiments, wherein the flame retardant composition further comprises a nitrogen-containing synergist.

Embodiment 21: A flame resistant polymer composition as defined in embodiment 20, wherein the nitrogen-containing synergist comprises a melamine or a melamine derivative.

Embodiment 22: A flame resistant polymer composition as defined in embodiment 20, wherein the nitrogen-containing synergist comprises a melamine cyanurate.

Embodiment 23: A polymer composition as defined in embodiment 1, wherein the insulating adjuvant comprises the mineral filler.

Embodiment 24: A polymer composition as defined in embodiment 23, wherein the mineral filler comprises pentacalcium hydroxide tris (orthophosphate).

Embodiment 25: A polymer composition as defined in embodiment 23, wherein the mineral filler comprises an oxide, a carbonate, or a sulfate.

Embodiment 26: A polymer composition as defined in embodiment 23, wherein the mineral filler comprises a hydroxyapatite.

Embodiment 27: A flame resistant polymer composition as defined in any of the preceding embodiments, wherein the polymer composition further contains an organometallic compatibilizer.

Embodiment 28: A flame resistant polymer composition as defined in embodiment 27, wherein the organometallic compatibilizer comprises a titanate.

Embodiment 29: A flame resistant polymer composition as defined in embodiment 27, wherein the organometallic compatibilizer comprises titanium IV 2-propanolato, tris (dioctyl) phosphato-O.

Embodiment 30: A flame resistant polymer composition as defined in any of embodiments 27 through 29, wherein the organometallic compatibilizer is present in the polymer composition in an amount of from about 0.05% by weight to about 2.5% by weight.

Embodiment 31: A flame resistant polymer composition as defined in any of the preceding embodiments, wherein the polymer composition further contains an ester of a carboxylic acid.

Embodiment 32: A flame resistant polymer composition as defined in embodiment 31, wherein the ester of the carboxylic acid comprises a reaction product of a montanic acid with a multi-functional alcohol.

Embodiment 33: A flame resistant polymer composition as defined in any of the preceding embodiments, wherein the polymer composition has a melt flow rate of at least about 4 cm³/10 min.

Embodiment 34: A flame resistant polymer composition as defined in embodiment 18, wherein the glass fibers are present in the composition in an amount of from about 10% by weight to about 40% by weight, such as from about 20% by weight to about 30% by weight.

Embodiment 35: A molded article made from the polymer composition as defined in any of the preceding embodiments, wherein the insulating adjuvant is present on a surface of the article.

Embodiment 36: An electrical connector that comprises at least two opposing walls between which a passageway is defined for receiving a contact element, the walls being formed from a polymer composition as defined in any of embodiments 1 through 34.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A polymer composition comprising:
a thermoplastic polymer comprising a polybutylene terephthalate polymer, the thermoplastic polymer being present in the polymer composition in an amount greater than about 35% by weight;
a flame retardant composition contained within the polymer composition, the flame retardant composition comprising a non-halogen flame retardant, the non-halogen flame retardant comprising a metal phosphinate, the non-halogen flame retardant being present in the polymer composition in an amount of at least about 10% by weight;
reinforcing fibers dispersed throughout a polymer matrix formed from the thermoplastic polymer;
an insulating adjuvant comprising:
(a) a polymer or wax having a critical surface tension of less than about 40 dynes/cm;
(b) a mineral filler containing calcium, titanium, barium, magnesium, or combinations thereof; or
(c) mixtures thereof;
and wherein the insulating adjuvant is present in the polymer composition in an amount less than about 5% by weight; and
wherein the polymer composition displays a comparative tracking index of at least 600 V and when tested according to a Vertical Burn Test according to Underwriters Laboratories Test 94, the polymer composition displays a rating of V-0 when tested at a thickness of 0.8 mm.

2. A polymer composition as defined in claim 1, wherein the insulating adjuvant comprises a polymer or wax having a critical surface tension of less than about 39 dynes/cm.

3. A polymer composition as defined in claim 1, wherein the insulating adjuvant comprises a polymer or wax having a contact angle of greater than about 70°.

4. A polymer composition as defined in claim 1, wherein the insulating adjuvant comprises a polymer or wax having a surface resistivity of greater than 10¹¹ ohm and a water absorption of less than 2.5%.

5. A polymer composition as defined in claim 1, wherein the insulating adjuvant comprises a polymer or wax having a melting point of less than about 222° C.

6. A polymer composition as defined in claim 1, wherein the insulating adjuvant comprises an aliphatic polyamide polymer.

7. A polymer composition as defined in claim 1, wherein the insulating adjuvant comprises polyamide 11 or polyamide 12.

8. A polymer composition as defined in claim 1, wherein the insulating adjuvant comprises a silicone and is present in the polymer composition in an amount from about 0.3% by weight to about 4% by weight.

9. A polymer composition as defined in claim 8, wherein the silicone is added to the polymer composition as a masterbatch comprising the silicone combined with a carrier polymer.

10. A polymer composition as defined in claim 1, wherein the polybutylene terephthalate polymer has a melt flow rate of greater than about 20 cm³/10 min, and less than about 100 cm³/10 min.

11. A polymer composition as defined in claim 1, wherein the polymer composition does not contain a carbodiimide.

12. A polymer composition as defined in claim 1, wherein the thermoplastic polymer further comprises a bone black pigment.

13. A polymer composition as defined in claim 1, wherein the reinforcing fibers comprise glass fibers and wherein the reinforcing fibers have an average fiber length of from about 1 mm to about 5 mm and have an average fiber diameter of from about 8 microns to about 15 microns.

14. A flame resistant polymer composition as defined in claim 1, wherein the flame retardant composition further comprises a nitrogen-containing synergist.

15. A flame resistant polymer composition as defined in claim 14, wherein the nitrogen-containing synergist comprises a melamine or a melamine derivative.

16. A flame resistant polymer composition as defined in claim 14, wherein the nitrogen-containing synergist comprises a melamine cyanurate.

17. A polymer composition as defined in claim 1, wherein the insulating adjuvant comprises the mineral filler.

18. A polymer composition as defined in claim 17, wherein the mineral filler comprises pentacalcium hydroxide tris (orthophosphate), an oxide, a carbonate, a sulfate, or a hydroxyapatite.

19. A flame resistant polymer composition as defined in claim 1, wherein the polymer composition further contains an organometallic compatibilizer.

20. An electrical connector that comprises at least two opposing walls between which a passageway is defined for receiving a contact element, the walls being formed from a polymer composition as defined in claim 1.
